(19) United States
(12) Patent Application Publication
(10) Pub. No.: US 2012/0082510 A1
(43) Pub. Date: Apr. 5, 2012

(54) ISO container adapter

(76) Inventor: Steven A. Lew, Bayville, NJ (US)

(21) Appl. No.: 12/924,787

(22) Filed: Oct. 5, 2010

(51) Int. Cl. F16B 2/02; F16B 2/00

(52) U.S. Cl. 403/373; 403/345

(57) ABSTRACT

A locking plate and a locking cylinder are inserted into a hole in the corner casting of an ISO container. Then the adapter is manipulated so that the locking plate having an adjustable tightening means formed thereon, contacts the inner surface of the corner casting. The adapter is secured by tightening the tightening means thereby drawing the locking plate and the mounting against the inner and outer surfaces, respectively, of the corner casting. Any structural or other fixture attached to the mounting plate is now secured. The tightening means may be; one or more bolts threadedly engaged in the mounting plate; one or more over center toggle clamps mounted in said mounting plate; or, a nut threadedly engaged to a threaded portion on the cylinder.

### FIELD OF THE INVENTION

The present invention is a support connector for military shipping containers, the support connector enabling portions of the military shipping container to provide structural support to components mounted on the exterior of the container.

### SUMMARY OF THE INVENTION AND DESCRIPTION OF RELATED ART

An intermodal container or freight container (commonly known as a shipping container) is a reusable transport and storage unit for moving products and raw materials between locations or countries; the terms container or box may be used on their own within the context of shipping. Containers manufactured to International Standards Organization (“ISO”) specifications may be referred to as ISO containers and the term high-cube container is used for units that are taller than normal. The container system developed from a design of 8-foot (2.438 m) cube units used by the United States' military and later standardized by extension to 10-foot (3.05 m), 20-foot (6.1 m), and 40-foot (12.19 m) lengths. Longer, higher and wider variants are now in general use in various places.

Twistlock and corner casting together form a standardised rotating connector for securing shipping containers. Their primary uses are for locking a container into place on a container ship, semi-trailer truck or railway container train, and for lifting of the containers by container cranes and sidelifters.

The female part of the connector is a corner casting fitted to the container itself, and which has no moving parts, only oval holes in the top or bottom and on the sides. There are four different castings as the hole locations must change to match the orientation of the particular corner they are designed for. The large hole (slot) always faces up or down and is used to secure containers together in vertical stacks. The two smaller holes face outward toward the side and front and are used to connect containers horizontally. The male component is the twistlock, which is fitted to cranes and transport bases. This can be inserted through a hole (it is roughly 4.1″ long and 2.2″ wide), and then the top portion (normally pointed to make insertion easier) is rotated 90° so that it cannot be withdrawn. The mechanism is the same as that of a Kensington lock on a much larger scale.

The maximum size and position of the holes in the connector is defined in international standard ISO 1161:1984. Using the corner casting on a shipping container, the twistlock is inserted through the larger oval hole on the bottom.

In a copending application, Ser. No. ______ filed of even date herewith in the names of Bullivant, Lew and Tierney, entitled RENEWABLE ENERGY SYSTEM, use of a military ACA QUADCON shipping container for housing, supporting and transporting portions of a solar panel and wind energy electrical generating system is described. The ACA QUADCON shipping container has corner castings which are ISO compliant as discussed above.

The present invention utilizes connection to the corner castings to provide quick connect and disconnect capability in supporting elements for the solar panels disclosed in the aforementioned co-pending application.

The adapter of the present invention includes a cylinder, a locking plate mounted either centrally or offset at or near one end of the cylinder, a mounting plate attached to the other end of the cylinder and a fastening means engaged in the mounting plate. The fastening means may be one or more bolts threadedly engaged in through holes in the mounting plate or nut adjustably mounted on threads formed on the exterior of a portion of the cylinder, or one or more over center toggle clamps attached to the mounting plate.

In operation, the locking plate and the cylinder are inserted into a hole in the corner casting. Then the adapter is manipulated so that the locking plate contacts the inner surface of the corner casting. The adapter is secured against the outer surface of the corner casting by tightening the bolts, adjusting the nut on the treaded portion of the cylinder or lowering the toggle clamps. Any structural or other fixture may now be secured attachment to the mounting plate is now secured.

### PRIOR ART

Three offerings from Tandemlock Inc. attach an ISO container with corner castings to a truck bed. This first unit has a handle that turns approximately 30° to secure the container. It still allows for slack in the connection.

http://www.tandemloc.com/0_securing/s_N2501BA.asp

This unit employs a cam that tightens down on a small portion of the corner casting. It does not employ the 90° twist lock action.

http://www.tandemloc.com/0_securing/S_K08A00A-1GA.asp

This connector is for pulling the container onto flatbed trucks. It employs the 90° twist lock feature and has a secondary nut that can be used to remove the slack:

http://www.tandemloc.com/0_securing/S_T15000A.asp

This is a shipboard hold down mounted onto a caster wheel. The locking plate is engaged by turning the handle which rotates the plate. Turning the side bolts closes the side plates similar to jaws in a vise, but as they close the jaws are forced upward by the angled mating edges of the main body. This effectively removes the slack in the joint and clamps the container in place.

http://www.tandemloc.com/0_mobilizing/M_AC49000A-XPA.asp

### BRIEF DESCRIPTION OF THE DRAWINGS

FIG. 1 is a perspective view of the adapter attached to a structural support; and

FIG. 2 is a side view of the adapter mounted in a corner casting;

FIG. 3 is a perspective view of another embodiment of the invention; and

FIG. 4 is a perspective view of a still further embodiment of the invention.

### DETAILED DESCRIPTION OF THE PREFERRED EMBODIMENT

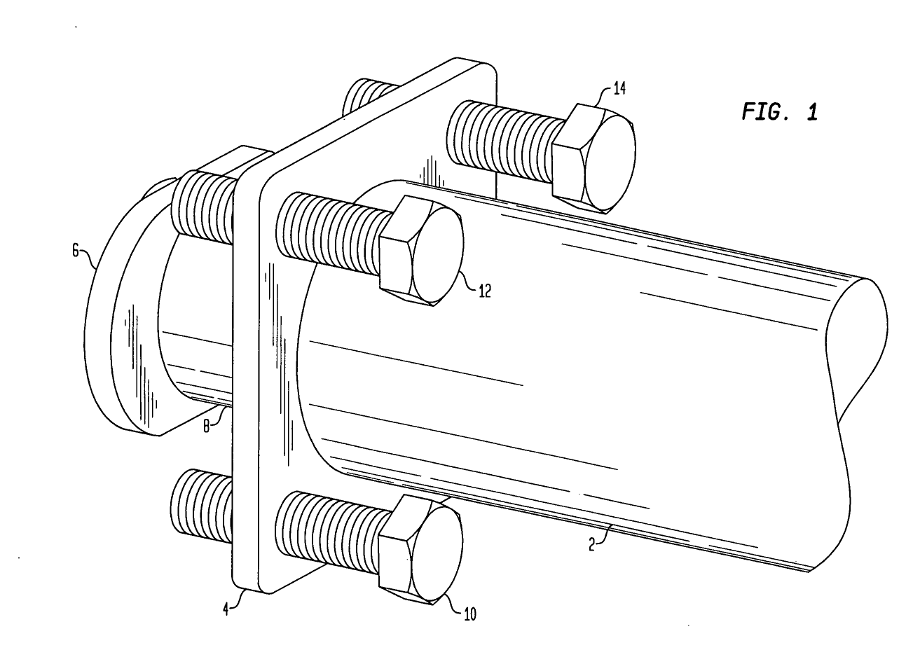

As shown in FIGS. 1-4, where like reference numerals are used to denote like parts, the adapter includes locking plate 6 attached to one end of cylinder 8. Mountng plates 1 or 4 are attached to the other end of cylinder 8. Bolts 10, 12 and 14 threadedly engage in mounting plate 4. A structrual support 2 is attached to the mounting plate. Different configurations of locking plates such as 1 or 4 may be used.

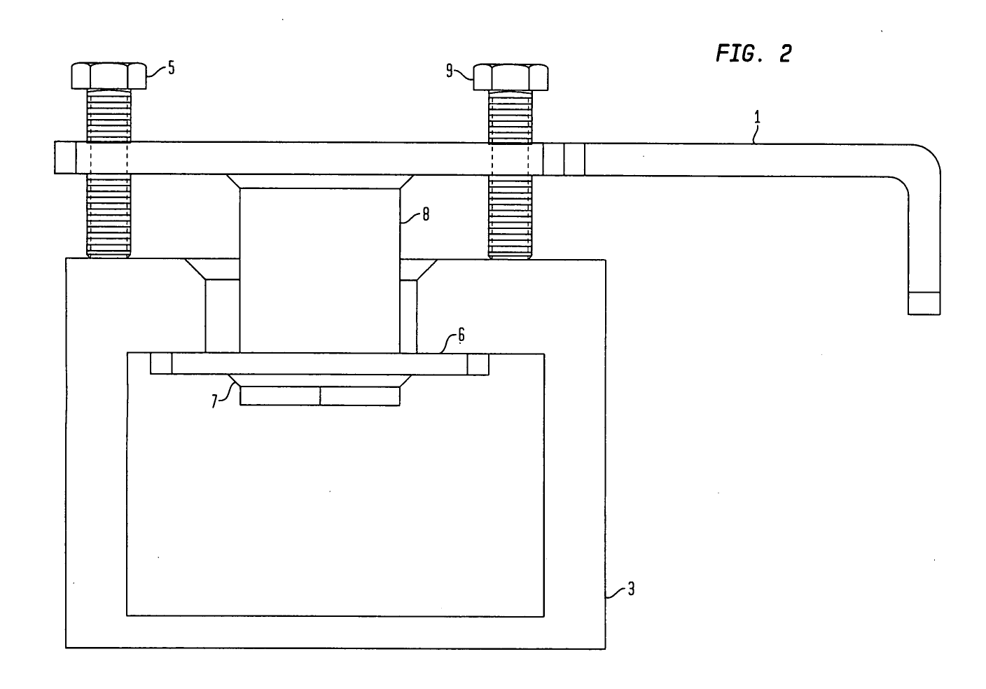

In FIG. 2, the adapter is positioned in a hole in corner casting 3 (shown in cross section). The mounting plate 1 has four bolts two of which, 5 and 9, are shown all threadedly engaged therein. Cylinder 8 is now drawn up when the bolts are tightened causing locking plate 6 to engage the inner surface of corner casting 3. Numeral 7 denotes a weld bead holding the locking plate onto the cylinder.

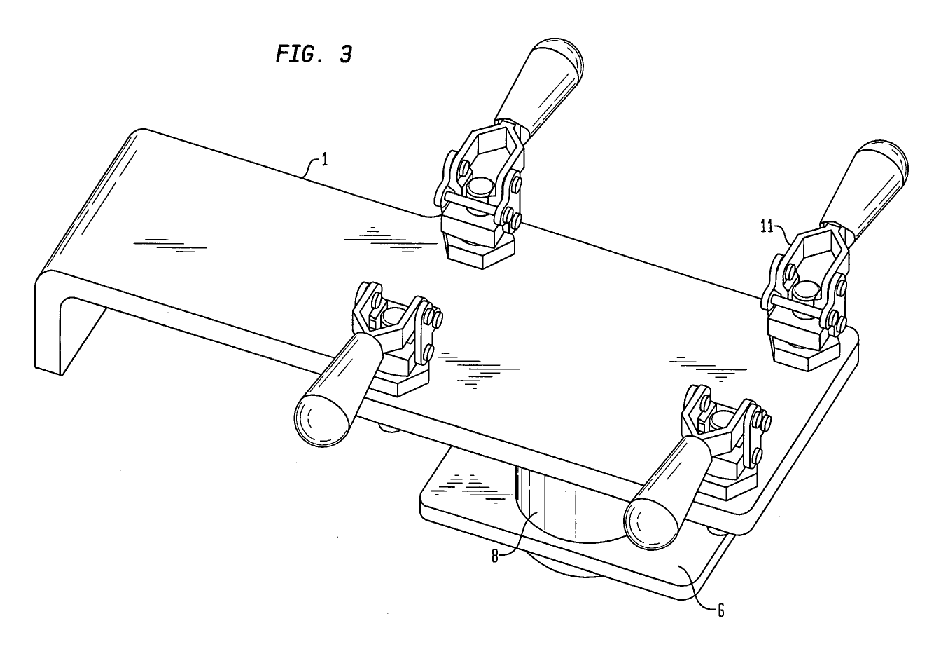

In FIG. 3, the bolts of FIGS. 1-2 are replaced with one or more over center toggle clamps one of which is denoted by numeral 11.

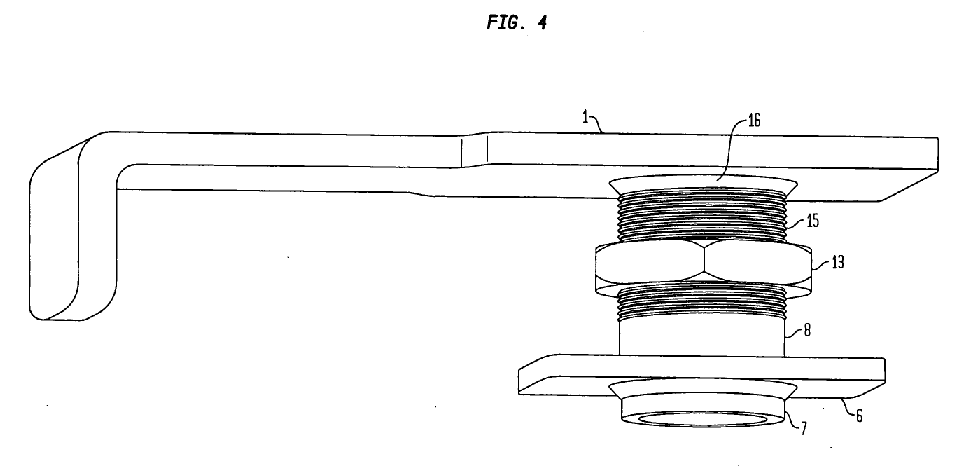

In FIG. 4, a nut 13 engages threaded portion 15 of cylinder 8, Numeral 16 denotes a weld bead attaching the cylinder to one side of mounting plate 1.

It will be appreciated that different configurations of locking plates and connectors attached thereto may be employed.

Further modifications to the methods and apparatus of the invention may be made without departing from the spirit and scope of the invention.

I claim:

1. An adapter comprising: a mounting plate; a locking plate; a locking cylinder attached between said mounting plate and said locking plate and adjustable tightening means formed in said adapter to hold said locking plate against a surface.

2. The adapter of claim 1 wherein said adjustable tightening means includes one or more over center toggle clamps mounted in said mounting plate.

3. The adapter of claim 1 wherein said adjustable tightening means includes one or more bolts threadedly engaged in said mounting plate.

4. The adapter of claim 1 wherein said cylinder has a threaded portion and said adjustable tightening means includes a nut threadedly engaged to said cylinder.

5. The adapter of claim 1 further including a structural support means attached to said mounting plate.
